(19) United States
(12) Patent Application Publication
(10) Pub. No.: US 2006/0104067 A1
(43) Pub. Date: May 18, 2006

(54) Heat-dissipating method and structure of backlight module of display device

(75) Inventors: Ping-Feng Hwang, Chu-Nan (TW); Bor-Jyh Pan, Chu-Nan (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/036,040

(22) Filed: Jan. 18, 2005

(30) Foreign Application Priority Data
Nov. 12, 2004 (TW) 093134563

(51) Int. Cl. F21V 29/00

(52) U.S. Cl. 362/373; 362/218

(57) ABSTRACT

The present invention discloses a heat-dissipating method and structure for a backlight module of a display device, which can improve the heat-dissipating ability of the backlight module of a display device. Via shifting the disposing direction of the liquid crystal panel, the present invention enables the control-drive element and the related circuit boards, which are disposed on the rear face of the backlight module, to keep away from the heat-concentrated region so that the disposing positions of the control-drive element and the circuit boards will not overlap the heat-concentrated region of the backlight module; thus, the heat-dissipating ability can be improved. In the preferred embodiment of the present invention, a heat-dissipating component, such as a set of heat-dissipating fins, is installed in the heat-concentrated region in order to increase the heat-dissipating area thereof; thus, the heat-dissipating ability can be further improved, and the heat distribution is to be uniform.

### FIELD OF THE INVENTION

The present invention relates to a backlight module of a display device, particularly to a heat-dissipating method and structure, which can improve the heat-dissipating ability of the backlight module of the display device.

### BACKGROUND OF THE INVENTION

A backlight module generally refers to an assembly of parts providing a back light source for the product, and the typical application thereof is the light source's provider of a flat panel display, such as a liquid crystal display panel.

As shown in FIG. 1 and FIG. 2, the horizontal and the vertical printed circuit board 11a and 11b, which connect the liquid crystal panel of a general TV, are typically installed separately in the edge of the top side and the left side of the liquid crystal display module 12; via a flexible printed circuit board, the horizontal and the vertical printed circuit board 11a and 11b also connect the control-drive element 10, which is installed near the top side of the rear face of the liquid crystal display module 12. The top side of the liquid crystal display module 12 is a region where the heat is apt to concentrate; however, disposing the circuit board 11a, 11b or the control-drive element 10 in the conventional positions will hinder the heat-dissipation.

FIG. 3 shows the disposition of the control-drive element 10a of the direct type backlight module 13 of a display device, wherein the light source is exemplified by a Cold Cathode Fluorescent Lamp 14 (CCFL), and the control-drive element 10a (e.g. an inverter) is disposed in one side of the backlight module 13; the CCFLs 14 need the same number of high voltage wires 10b as that of CCFLs 14 themselves to connect the control-drive element 10a through the path of the shortest distance. As shown in FIG. 10, if the territory of the temperature distribution on the backlight module 13 is checkerboarded into nine sections of from T1 to T9, it is to be found that the temperature distribution thereof is not uniform, and the relation of temperatures thereof is: T3>T2>T1, T6>T5>T4, T9>T8>T7.

The hot air flow or the heat energy generated by the control-drive element 10a, 10b and the circuit board 11a, 11b is apt to concentrate in some localized portions of the liquid crystal display module 12 or the backlight module 13, which hinders the heat-dissipation, and induces the temperature non-uniformity of the light-emitting face of the liquid crystal display module 12 or the backlight module 13. The non-uniformity of temperature will further induce the distortion of the optical material layer, which further influences the image quality.

### SUMMARY OF THE INVENTION

The primary objective of the present invention is to solve the temperature non-uniformity resulting from the heat generated by the backlight module of the conventional display device.

Primarily via the means of shifting the disposing direction of the liquid crystal panel, the method proposed by the present invention can enable the circuit boards and the control-drive element, which are disposed on the rear face of the backlight module, to keep away from the heat-concentrated region of the backlight module so that the disposing positions of the circuit boards and the control-drive element will not overlap the heat-concentrated region of the backlight module. In other words, the means is to rotate the liquid crystal panel and its related parts 180 degrees with respect to the backlight module to enable the primary heat-generating elements, such as the circuit boards and the control-drive element, to be positioned in the region lower to the region which the natural convective air current is apt to flow toward, and in cooperation with the natural uprise of the hot air or the heat energy, to enable the temperature distribution to be more uniform, so that the heat will not concentrate in the top side or other localized regions of the backlight module as in the conventional design. Thus, the aforementioned objective is achieved.

Another objective of the present invention is to provide a heat-dissipating structure, which improves the heat-dissipating ability of the backlight module.

Via translating the control-drive element, which is disposed in the rear face of the backlight module, to the relatively lower portion of the backlight module, the present invention empties the backlight module's upper portion where the heat is apt to concentrate, and the present invention further installs a heat-dissipating component in the region where the heat concentrates in order to increase the heat-dissipating area, so that the heat-dissipating ability is improved.

The preferred embodiments and detailed technical contents will be described below in cooperation with the drawings.

### BRIEF DESCRIPTION OF THE DRAWINGS

FIG. 1 is a diagram showing the disposing positions of the horizontal and vertical printed circuit boards of a conventional liquid display module.

FIG. 2 is the front view of FIG. 1, which shows the disposing position of the control-drive element.

FIG. 3 shows the disposition of the control-drive element of the conventional direct type backlight module of the display device.

FIG. 4 is a diagram showing the disposing positions of the horizontal and vertical printed circuit boards of the backlight module of the display device of the present invention.

FIG. 5 is the front view of FIG. 4, which shows the disposing position of the control-drive element.

FIG. 6, FIG. 7 and FIG. 8 are diagrams of one preferred embodiment of the backlight module of the display device of the present invention, which shows several types of heat-dissipating fins formed on the metallic housing of the backlight module of the display device.

FIG. 9 is diagram of another preferred embodiment of the backlight module of the display device of the present invention, wherein the backlight module adopts a plate lamp as the single planar light source.

FIG. 10 is the temperature distribution diagram of a conventional backlight module.

FIG. 11 is the temperature distribution diagram of the backlight module of the display device of the present invention.

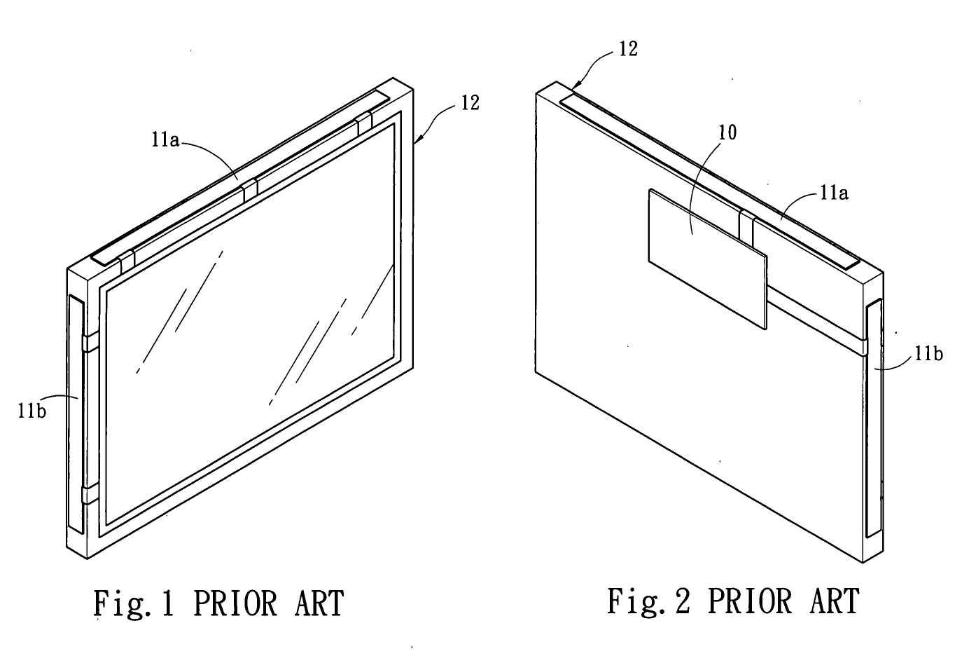

### THE PREFERRED EMBODIMENTS OF THE PRESENT INVENTION

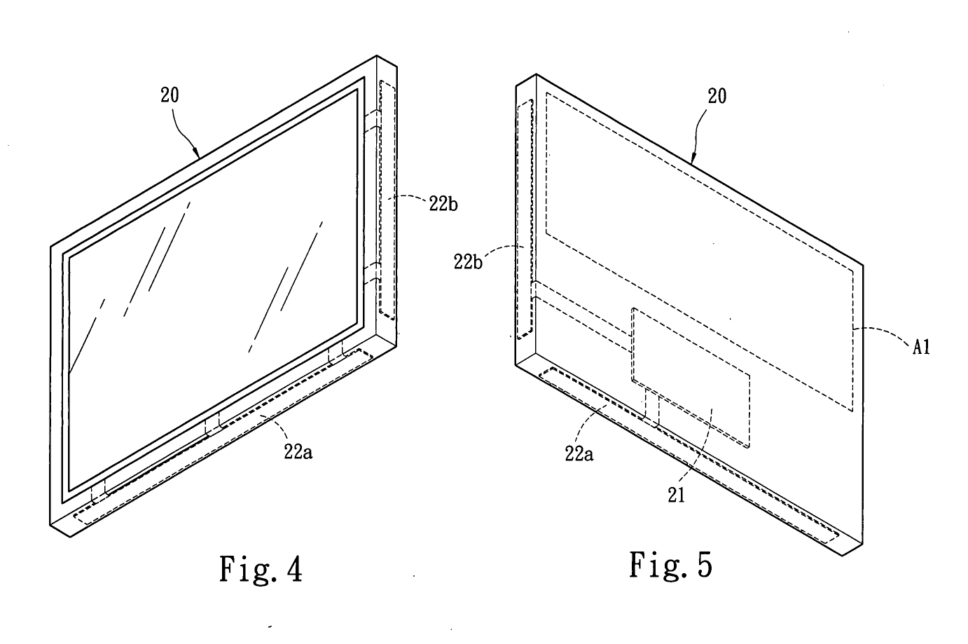

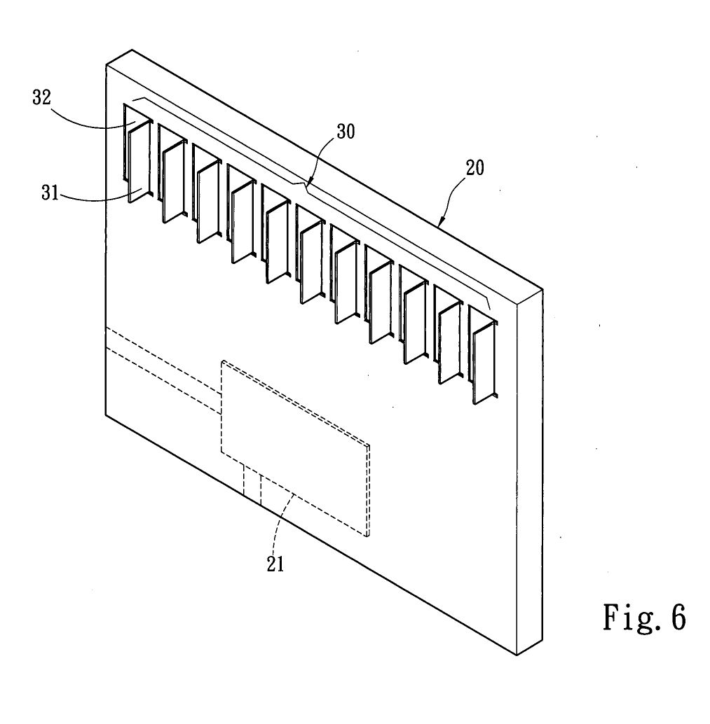

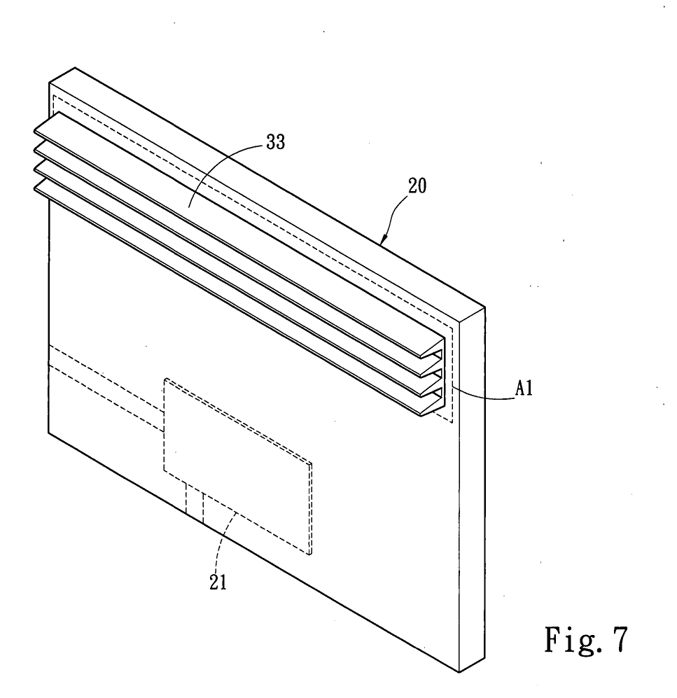

The method disclosed in the present invention can apply to the conventional liquid crystal display module, wherein the circuit board or the control-drive element is installed near the top side or a lateral side of the rear face of the backlight module 20 of the display device. As shown in FIG. 4 and FIG. 5, via rotating the liquid crystal panel (not shown in the drawings) 180 degrees, the present invention enables the control-drive element 21 and the circuit boards 22a, 22b to be translated to the relatively lower portion of the rear face of the backlight module 20, and enables the temperature distribution to be more uniform in cooperation with the natural uprise of the hot air or the heat energy. It can also be a preferred embodiment of the present invention to translate the related circuit boards 22a, 22b of the backlight module 20 to the bottom edge of the backlight module 20 to avoid the heat-dissipating hindrance resulting from the circuit boards 22a, 22b.

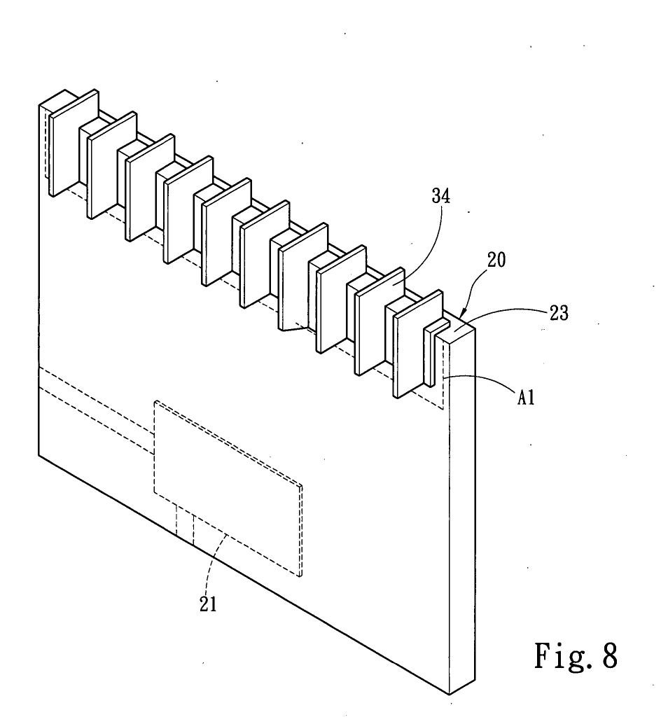

FIG. 6 shows a first embodiment of the present invention, wherein via shifting the disposing direction of the liquid crystal panel, the control-drive element 21 and the circuit boards 22a, 22b are translated to the relatively lower portion of the backlight module 20 in order to empty the region A1 where the heat is apt to concentrate, so that the region A1 has no any control-drive element 21 or related circuit boards 22a, 22b, wherein the region A1 is a potion of the surface of the backlight module 20 and near the top side thereof. Further, a heat-dissipating component 30 can be installed in the heat-concentrated region A1 in order to increase the heat-dissipating area of the heat-concentrated region A1, so that the heat-dissipating ability is improved.

Besides, the upside-down image resulting from rotating the liquid crystal panel can be easily solved via modifying the software (such as a video driver program) or the video driving firmware to process the video driving signal upside down.

FIG. 6 shows a first embodiment of the heat-dissipating component 30, which is fabricated via directly stamping a portion of the metallic housing of the backlight module 20 to form a plurality of heat-dissipating fins 31 and through-holes 32, wherein the through-holes 32 helps the hot air or hot convention to flow, and the glued reflective sheet can also function to avoid the dust coming in through the through-holes 32. FIG. 7 discloses a second preferred embodiment of the heat-dissipating component 30, wherein a set of heat-dissipating fins 33 is directly installed in the heat-concentrated region A1 of the rear face of the backlight module 20 in order to increase the heat-dissipating area thereof. As shown in FIG. 8, via extending the heat-dissipating fin 34 to the top surface 23 of the backlight module 20 and in cooperation with the open trench of the upper steel frame that fixes the liquid crystal panel (not shown in the drawings), the heat-dissipating ability will be further improved.

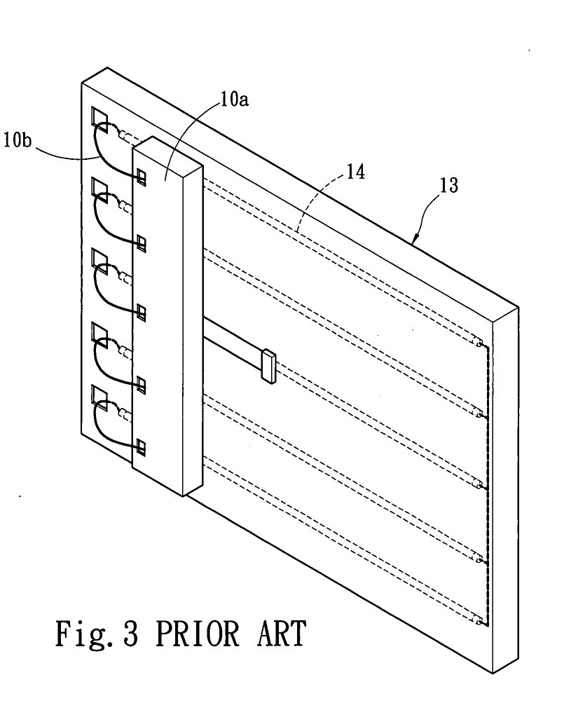

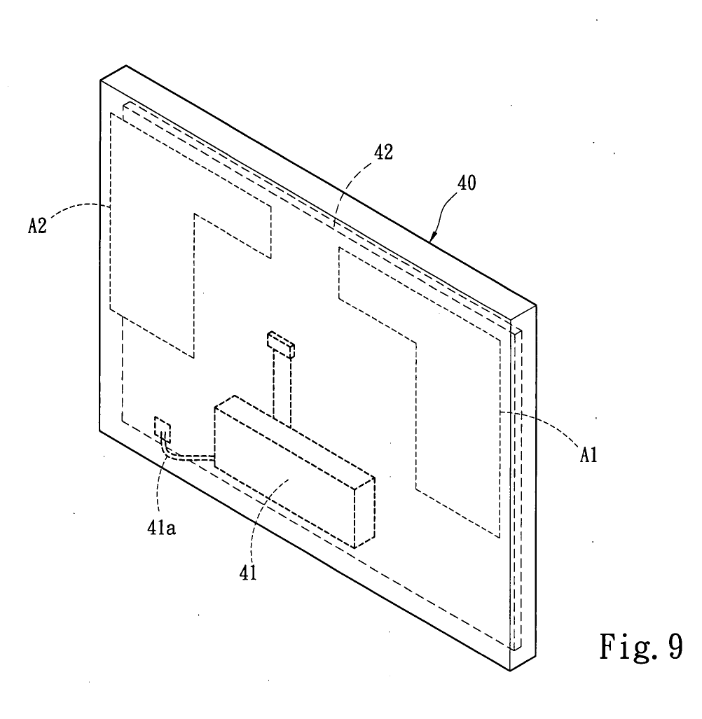

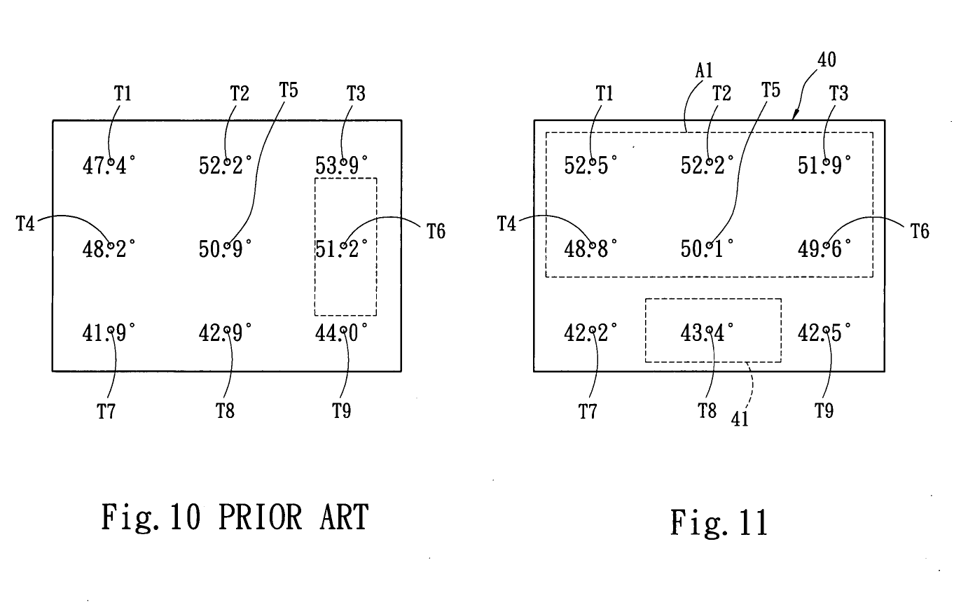

FIG. 9 discloses an embodiment applicable to the backlight module 40 adopting a plate lamp as the single planar light source. In contrast with the conventional direct type backlight module (as shown in FIG. 3) that needs the same number of high voltage wires 10b as that of the CCFLs to connect the control-drive element 10a (such as an inverter) through the path of the shortest distance, the high voltage power wires 41a is simplified to be only one set, so that the plate lamp 42 can be easily connected to the control-drive element 41. Thus, the control-drive element 41 (such as an inverter) shown in FIG. 9 can be translated to the region near the bottom side of the rear face of the backlight module 40 to enable the region near the top side of the rear face of the backlight module 40 to concentrate the heat more easily and keep away from the regions A1 and A2 where the circuit boards of the liquid crystal panel and the system are installed. The regions A1 and A2 have about the same heat-dissipating area and won't be influenced by the single-side heat-generation of the traditional control-drive element 41 (such as an inverter). As shown in FIG. 11, if the territory of the temperature distribution on the rear face of the backlight module 40 is also checkerboarded into nine sections of from T1 to T9, it will be found that the temperature distributions of the light-emitting face of the backlight module 40 are equal in either the right or the left potion. Further, the aforementioned heat-dissipating component 30 can also be installed in the emptied heat-concentrated regions A1 and A2 in order to increase the heat-dissipating ability. Besides, in the multi-lamp light source, if all the input power wires can be integrated into only one set of output wires at a single position, the connection of the high voltage power wires can also be simplified, and the heat-dissipating structure of the present invention can also apply to this case.

Those described above are only the preferred embodiments of the present invention, and it is not intended to limit the scope of the present invention. Any modification and variation according to the claims of the present invention is to be included within the scope of the present invention.

What is claimed is:

1. A heat-dissipating method for a backlight module of a display device, for improving the heat-dissipating problem resulted from at least one circuit board installed near the top side of the rear face of said backlight module and hindering the heat-dissipation of said backlight module, wherein said display device comprises a liquid crystal panel, said method comprising:
shifting the disposing direction of said liquid crystal panel, for enabling said circuit board to be moved to the region near the bottom side of said backlight module so that the region near said top side of said backlight module is emptied; and
installing a heat-dissipating component in the region near said top side, for increasing the heat-dissipating area and improving the heat-dissipating ability.

2. The heat-dissipating method according to claim 1, wherein said heat-dissipating component is a set of heat-dissipating fins.

3. The heat-dissipating method according to claim 2, wherein said set of heat-dissipating fins is fabricated via stamping the metallic housing of said backlight module to form a plurality of heat-dissipating fins and through-holes.

4. The heat-dissipating method according to claim 2, wherein said set of heat-dissipating fins is extended to the top surface of said backlight module.

5. A heat-dissipating structure for a backlight module of a display device, for improving the heat-dissipating problem resulted from at least one circuit board installed near the top side of the rear face of said backlight module and hindering the heat-dissipation of said backlight module, comprising:
a heat-concentrated region where the heat is apt to concentrate, wherein said heat-concentrated region is positioned near said top side of the rear face of said backlight module, and no circuit board is installed in said heat-concentrated region; and
a heat-dissipating component, installed in said heat-concentrated region in order to increase the heat-dissipating area thereof.

6. The heat-dissipating structure according to claim 5, wherein said heat-dissipating component is a set of heat-dissipating fins.

7. The heat-dissipating structure according to claim 6, wherein said set of heat-dissipating fins is fabricated via stamping the metallic housing of said backlight module to form a plurality of heat-dissipating fins and through-holes.

8. The heat-dissipating structure according to claim 6, wherein said set of heat-dissipating fins is extended to the top surface of said backlight module.

9. The heat-dissipating structure according to claim 6, wherein said backlight module further comprises a control-drive element for connecting said circuit board and being installed in the region near the bottom side of said rear face of said backlight module.

10. A backlight module for a display device, for providing a backlight for a liquid crystal panel, comprising at least a light source, a housing, and at least a control-drive element; characterized in:
a heat-concentrated region being positioned near the top side of the rear face of said backlight module, wherein the heat is apt to concentrate on said heat-concentrated region and no said control-drive element is installed in said heat-concentrated region; and
said control-drive element being installed near the bottom side of the rear face of said backlight module in order to drive said light source.

11. The backlight module according to claim 10, further comprising a heat-dissipating component installed in said heat-concentrated region, wherein the heat is apt to concentrate on said heat-concentrated region and the circuit boards of said liquid crystal panel and other systems keep away from said heat-concentrated region.

12. The backlight module according to claim 11, wherein said heat-dissipating component is a set of heat-dissipating fins.

13. The backlight module according to claim 12, wherein said set of heat-dissipating fins is fabricated via stamping the metallic housing of said backlight module to form a plurality of heat-dissipating fins and a plurality of through-holes penetrating through the metallic housing.

14. The backlight module according to claim 12, wherein said set of heat-dissipating fins is extended to the top surface of said backlight module.

15. The backlight module according to claim 10, wherein said light source is a tube lamp or a plate lamp.

16. The backlight module according to claim 10, wherein the input power wires of said light source are integrated into a set of output power wires at a single position.
